(19) United States
(12) Patent Application Publication
(10) Pub. No.: US 2026/0196370 A1
(43) Pub. Date: Jul. 9, 2026

(54) CONTAINER FOR RECEIVING RADIOACTIVE WASTE

(71) Applicant: LEMER PAX, LA CHAPELLE SUR ERDRE (FR)

(72) Inventor: Pierre-Marie LEMER, Nantes (FR)

(73) Assignee: LEMER PAX, LA CHAPELLE SUR ERDRE (FR)

(21) Appl. No.: 19/136,465

(22) PCT Filed: Dec. 8, 2023
(86) PCT No.: PCT/EP2023/084963

§ 371 Date: Jun. 6, 2025

(30) Foreign Application Priority Data
Dec. 9, 2022 (FR) FR2213056

(51) Int. Cl. G21F 5/12

(52) U.S. Cl. CPC G21F 5/12

(57) ABSTRACT

A container for receiving radioactive waste, the container, which is at least partly made of radioprotective material, includes a container body, the upper edge of which bounds an upper opening of the container, and a cover element. The cover element includes a closing plate which is mounted so as to be movable in horizontal translation at the upper opening of the container by two later slide structures. The closing plate includes a plate through-opening and is provided with a movable closing flap designed to assume: a closed position in which it closes the plate through-opening; and an open position in which it at least partially uncovers the plate through-opening.

### TECHNICAL FIELD

The present invention relates to the technical field of containers at least partly made of a radioprotective material, which are intended to receive radioactive waste, for example, but not exclusively, for the containment and decay of contaminated and radioactive waste from care activities involving infectious risks, as part of certain nuclear medicine activities.

### BACKGROUND

There exist containers at least partly made of a radio-protective material (lead, tungsten or other), for receiving radioactive waste coming for example from nuclear medicine activities.

These containers have a container body defining an inner storage volume, provided with an upper opening and associated with a removable cover element.

Conventionally, the cover element is pivotally mounted on an upper edge of the container body, about a horizontal axis; and it may be operated manually or by foot, by means of a control pedal.

However, the heavy weight of the radio-protective materials means that opening and closing the cover is not always straightforward.

Moreover, the degree to which the cover opens is not easy to control, in particular depending on the size (or volume) of the waste(s) involved, which may be source of overexposure to ionizing radiation.

### SUMMARY

In order to remedy the above-mentioned drawbacks of the state of the art, the present invention proposes a container made of a radioprotective material for receiving radioactive waste, wherein said container comprises:
a container body at least partly made of a radioprotective material, said container body comprising a bottom element extended by a belt of lateral walls, an upper edge of said belt of lateral walls delimiting an upper container opening, and
a cover element, at least partly made of a radioprotective material, designed to occupy a closed position in which said cover element closes said upper container opening, and an open position in which said cover element at least partially uncovers said upper container opening, said container being characterized in that said cover element comprises a closing plate comprising an upper face and a lower face, said closing plate being mounted mobile in horizontal translation at said upper container opening through two lateral slide structures, said closing plate comprising a plate through-opening and being provided with a movable closing flap designed to occupy a closed position in which said closing flap closes said plate through-opening, and an open position in which said closing flap at least partially uncovers said plate through-opening.

Such a container structure makes it possible to limit the efforts for opening and closing the cover, and makes it possible to easily control the opening required to adapt to the size of the waste to be stored, while reducing to the bare essentials the irradiation cone to which it is exposed.

Other non-limiting and advantageous features of the container according to the invention, taken individually or according to all the technically possible combinations, are the following:
the closing flap may be arranged on the side of the upper face of the closing plate and be pivotally mounted about a pivot axis, said pivot axis extending perpendicular to the plane of said closing plate, to allow said closing flap to be opened and closed by pivoting in a plane parallel to that of said closing plate;
the closing flap may be cantilevered, parallel to and at a distance from said closing plate, by means of a pivot shaft which represents said pivot axis;
the container may include a stop system comprising two stop structures to limit the pivoting of the closing flap in its two moving directions;
the stop system may include a finger integral with one of the closing plate and the closing flap, said finger travelling within a groove provided in the other of said closing plate and said closing flap, the ends of said groove forming said two stop structures; such a feature makes the stop system invisible;
the plate through-opening may be of circular shape, the closing flap may be of generally circular shape, with a lateral extension at which said pivot axis is formed, and said closing flap may comprise an operating handle consisting of a vertical rod at the free end of which is formed a grip sphere, said operating handle extending diametrically opposite with respect to said lateral extension;
the lateral slide structures may be formed, for a part, on the outer sides of two parallel walls of the belt of lateral walls, and for another part, on faces facing two supports that extend downwards two parallel sides of the closing plate;
the lateral slide structures may comprise: (a) stop structures to define the open and closed positions of the closing plate, and (b) braking means designed to brake the motion of said closing plate just before it reaches said stop structures;
the container may comprise two grip handles, for sliding the closing plate, said grip handles being arranged on said two supports that extend downwards two parallel sides of the closing plate;
the container body comprises a container body vertical axis, said container comprising a base structure with castors for support on the ground, and said base structure being offset with respect to said container body vertical axis, in a way that avoids, or at least limits, the possibility of the container tipping over when said closing plate is in the open position.

Obviously, the different features, alternatives and embodiments of the invention can be associated with each other according to various combinations, insofar as they are not mutually incompatible or exclusive.

### BRIEF DESCRIPTION OF THE FIGURES

Moreover, various other features of the invention emerge from the appended description made with reference to the drawings that illustrate non-limiting embodiments of the invention, and wherein:

FIG. 1 is a schematic perspective view of a container for radioactive waste according to the invention, with its closing plate in the closed position and its closing flap in the open position;

FIG. 2 is a perspective view of the container illustrated in FIG. 1, with the closing flap in the closed position;

FIG. 3 is a front view of the container illustrated in FIG. 2;

FIG. 4 is a cross-sectional view according to the section plane 4-4 of FIG. 3;

FIG. 5 is an enlarged view of a detail B of FIG. 4;

FIG. 6 is a perspective view of the container for radioactive waste illustrated in FIGS. 1 to 5, with its closing plate in the open position and its closing flap in the closed position.

### DETAILED DESCRIPTION

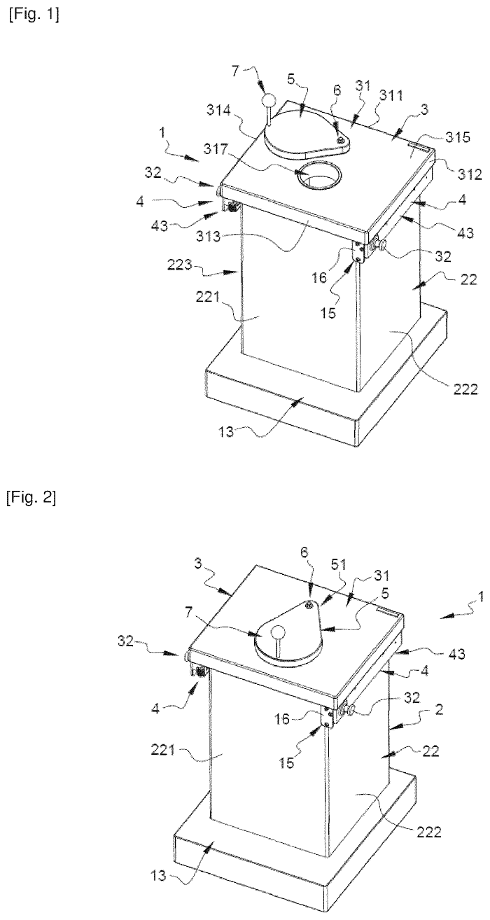

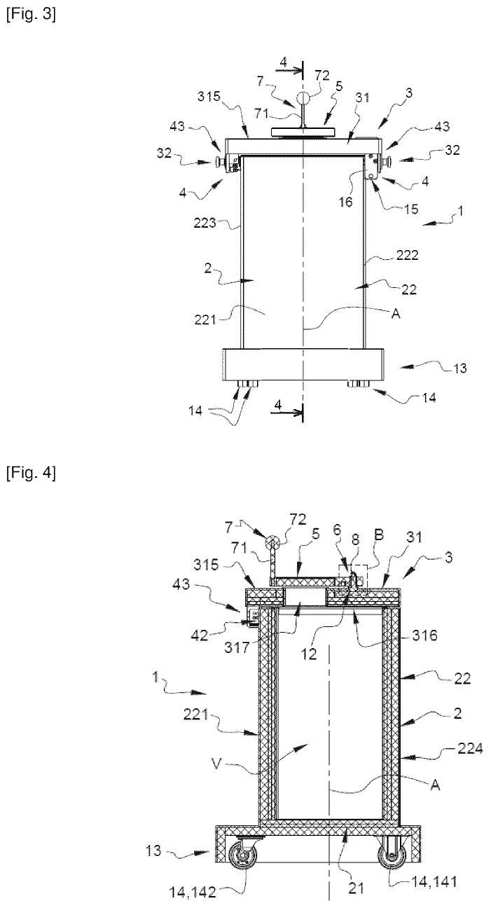

The container 1 illustrated in FIGS. 1 to 6 is intended to receive radioactive waste, for example for the storage, containment and decay of contaminated and radioactive waste from care activities in nuclear medicine.

This container 1 comprises a container body 2 associated with a cover element 3.

The container body 2 and the cover element 3 are at least partly made of a radioprotective material in a manner adapted to stop ionising radiation likely to be emitted by stored waste.

The container body 2 comprises a horizontal bottom element 21, extended by a belt of lateral walls 22, which define together a storage volume V and a container body vertical axis A.

The belt of lateral walls 22 comprises four vertical lateral walls 221, 222, 223 and 224, and its horizontal cross-section is square or rectangular in shape. The two walls 221 and 224 are parallel to each other; and the two walls 222 and 223 are parallel to each other.

The upper edges of the four lateral walls 221, 222, 223, 224 are located in a same horizontal plane and they delimit an upper container opening 225.

The cover element 3 is designed to occupy a closed position (FIGS. 2, 3 and 4) in which it closes the upper container opening 225, and an open position (FIGS. 1 and 6) in which it at least partially uncovers this upper container opening 225.

The cover element 3 comprises a closing plate 31, which is delimited by four sides 311, 312, 313 and 314, an upper face 315 and a lower face 316.

This cover element 3 is mounted so as to be horizontally movable in translation at the upper container opening 225, via two lateral slide structures 4 that are arranged along two lateral sides of the closing plate 31 (here the sides 312 and 314) and along the upper edge of two parallel lateral walls of the belt of lateral walls 22 (here the lateral walls 222 and 223).

Moreover, the closing plate 31 comprises a plate through-opening 317 (here, circular in shape); and it is provided with a movable closing flap 5, designed to occupy a closed position in which this closing flap 5 closes the plate through-opening 317 (FIGS. 2, 3, 4 and 6), and an open position in which the closing flap 5 at least partially uncovers this plate through-opening 317 (FIG. 1).

For that purpose, the closing flap 5 is pivotally mounted, on the side of the upper face 315 of the closing plate 31, about a pivoting axis 6 that extends perpendicular to the plane of the closing plate 31, to allow said closing flap 5 to be opened and closed by pivoting in a plane parallel to that of said closing plate 31.

This closing flap 5 is of generally circular shape, with a lateral extension 51 at which said pivot axis 6 is formed. The closing flap 5 is moved by means of an operating handle 7 (or lever) consisted of a vertical rod 71 at the free end of which is arranged a grip sphere 72. This operating handle 7 extends diametrically opposite with respect to the above-mentioned lateral extension 51.

The colour of the grip sphere 72 may be adapted according to the energy of the radioisotope(s) stored in the container 1. For example, it may be orange for protection against high energy radiation, and blue for protection against low and medium energy radiation.

This operating handle 7 makes it possible to open the pivoting closing flap 5, not only with one hand, but also with the elbow, for example to avoid the contamination thereof with soiled gloves.

To facilitate the operation thereof, the closing flap 5 is cantilevered, parallel to and at a distance from the upper face 315 of the closing plate 31, by means of a pivot shaft 8 which represents said pivot axis 6.

The pivot shaft 8 is integral with the closing plate 31 and extends upwards, from the upper face 315 of said closing plate 31 and perpendicular to the latter.

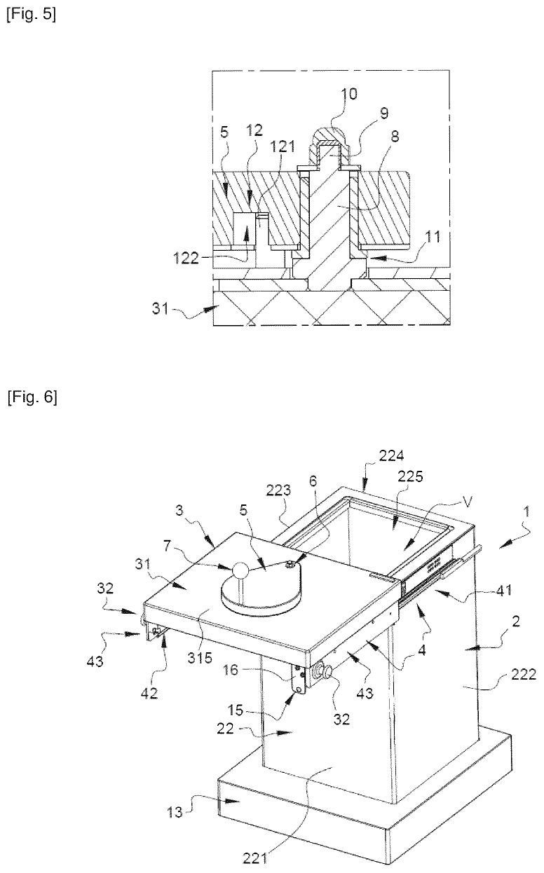

As can be seen in FIG. 5, the free end of the pivot shaft 8 comprises a threaded part 9 for receiving a locking nut 10; and a spacer washer 11 is mounted on the pivot shaft 8, interposed between the upper face 315 of the closing plate 31 and the closing flap 5, to obtain the required spacing.

The pivot shaft 8 may be integral with a support plate attached by means of screws to the closing plate 31.

The container 1 also includes a stop system 12, comprising two stop structures, to limit the pivoting of the closing flap 5 in its two moving directions.

Particularly interestingly, this stop system 12, visible in FIG. 5, includes a finger 121, here integral with the closing plate 31, which travels within a circular-arc groove 122 formed opposite the closing flap 5, the ends of this circular-arc groove 122 forming the two above-mentioned stop structures, one to define the closed position of the closing flap 5 and the other to define its maximum open position.

The desired pivoting angle is controlled by the positioning and the length of the groove 122.

More precisely, the finger 121 extends upwards from the upper face 315 of the closing plate 31, and enters the groove 122 formed opposite thereof in a lower face of the closing flap 5.

It is understood that the pivoting of the closing flap 5 is possible as long as the finger 121 does not enter in contact with one of the ends of the groove 122.

Such a structure of the stop structure 12 allows it to be fully integrated and invisible from the outside.

In an alternative embodiment, the groove of the stop system 12 may be formed in the upper face of the closing plate 31, the associated finger being then formed in protrusion from the lower face of the closing flap 5.

The bottom element 21 of the container body 2, the belt of lateral walls 22 and the closing plate 31 may be consisted of a multilayer complex formed of:
at least one protective layer made of a radioprotective material (for example, one or several layers of lead, or another radioprotective material, or a plurality of layers of different radioprotective materials),
at least one support layer for said protective layer(s) (for example, a plywood or chipboard panel),
layers of inner and outer coating (for example, plastic, resin or metal).

The total thickness of the layer(s) of radioprotective material(s) is adapted according to the desired radioprotective characteristics. This total thickness of the layer(s) of radioprotective material may be between 10 and 20 mm for a material such as lead.

The wall that delimits the circular opening 317 of the closing plate 31 is preferably covered by an attached cladding shell (for example, made of plastic, resin or metal).

For its part, the closing flap 5 may be consisted of a layer of radioprotective material (for example, a layer of lead), covered with a coating material (for example, plastic, resin or metal).

The lateral slide structures 4 are each arranged, for a part 41, on an outer side of the upper edge of a lateral wall 222, 223, and for another part 42, on a face of a support 43 that extends downwards a side 312, 314 of the closing plate 31.

The two parts 41 and 42 of each slide structure 4 are complementary.

The two parts 41 of the two slide structures 4 are facing away from each other on the container body 2; and the two parts 42 of the two slide structures 4 are facing each other on the facing faces of the two supports 43.

Two grip handles 32 are provided to facilitate the translation of the closing plate 31.

These grip handles 32 are formed on the two supports 43, here at one of the ends of these two supports 43.

More precisely, the handles 32 protrude from the outer faces of the two supports 43, i.e. from their faces that are opposite to those which receive the parts 42 of the slide structures 4.

The two handles 32 can be operated manually or with the knee when required by the waste bulk.

The slide structures 4 include stop structures (not visible) that define the open and closed positions of the closing plate 31, as well as braking means (also not visible) designed to brake the movement of the closing plate 31 just before it reaches the above-mentioned stop systems.

Said braking means may for example be consisted of profiles or plates of the two parts 41, 42 of the two slide structures 4, which cooperate together in friction. Adjustment screws may be provided to deform one of said profiles or plates to a greater or lesser extent, in order to obtain the desired braking characteristics.

The container 1 comprises an enclosed base structure 13 with castors 14 for support on the ground, two of which 141 are fixed and two others 142 are pivoting.

As can be seen in FIGS. 1, 2, 4 and 6, the base structure 13 is offset (or shifted) with respect to the container body vertical axis A, in a way that avoids, or at least limits, the possibility of the container 1 tipping over when the closing plate 31 is in the open position.

Said offset or shift is made on the side located in the direction of opening of the closing plate 31.

A lock system can be provided to prevent the opening of the closing plate 31. For example, a padlock locking system (not shown) may be provided, which fits:
on a hole 15 of a first locking plate 16, integral with the closing plate 31, and
on a hole of a second locking plate (not visible) integral with the container body 2.

Moreover, a bag attaching frame may be provided to guarantee the holding of a waste receiving bag, in the storage volume V of the container body 2.

It is understood that the container 1 for radioactive waste in accordance with the invention can be opened without effort due to the sliding nature of its cover element 3.

Such a sliding cover element 3 further reduces exposure for operators due to the presence of the closing flap and its ability to partially open.

1-10. (canceled)

11. A container for receiving radioactive waste, wherein said container comprises:
a container body at least partly made of a radioprotective material, said container body comprising a bottom element extended by a belt of lateral walls, an upper edge of said belt of lateral walls delimiting an upper container opening, and
a cover element, at least partly made of a radioprotective material, designed to occupy a closed position in which said cover element closes said upper container opening, and an open position in which said cover element at least partially uncovers said upper container opening,
wherein said cover element comprises a closing plate comprising an upper face and a lower face, said closing plate being mounted mobile in horizontal translation at said upper container opening through two lateral slide structures, and wherein said closing plate comprises a plate through-opening, and is provided with a movable closing flap, designed to occupy a closed position in which said closing flap closes said plate through-opening, and an open position in which said closing flap at least partially uncovers said plate through-opening.

12. The container according to claim 11, wherein said closing flap is arranged on the side of the upper face of said closing plate and is pivotally mounted about a pivot axis, said pivot axis extending perpendicular to the plane of said closing plate, to allow said closing flap to be opened and closed by pivoting in a plane parallel to that of said closing plate.

13. The container according to claim 12, wherein said closing flap is cantilevered, parallel to and at a distance from said closing plate, by a pivot shaft which represents said pivot axis.

14. The container according to claim 12, further comprising a stop system comprising two stop structures to limit the pivoting of said closing flap in its two moving directions.

15. The container according to claim 14, wherein said stop system includes a finger integral with one of the closing plate and the closing flap, said finger travelling within a groove provided in the other of said closing plate and said closing flap, the ends of said groove forming said two stop structures.

16. The container according to claim 12, wherein said plate through-opening is of circular shape, wherein said closing flap is of generally circular shape, with a lateral extension at which said pivot axis is formed,
and said closing flap comprises an operating handle consisting of a vertical rod at the free end of which is formed a grip sphere, said operating handle extending diametrically opposite with respect to said lateral extension.

17. The container according to claim 11, wherein said lateral slide structures are formed, for a part, on the outer sides of two parallel walls of the belt of lateral walls, and for another part, on faces facing two supports that extend downwards two parallel sides of said closing plate.

18. The container according to claim 17, wherein said lateral slide structures comprise:
stop structures to define the open and closed positions of said closing plate, and
braking means designed to brake the motion of said closing plate just before it reaches said stop structures.

19. The container according to claim 17, further comprising two grip handles, for sliding said closing plate, said grip handles being arranged on said two supports that extend downwards two parallel sides of said closing plate.

20. The container according to claim 11, wherein said container body comprises a container body vertical axis (A),
wherein said container comprises a base structure with castors for support on the ground, and wherein said base structure is offset with respect to the container body vertical axis (A), in a way that avoids, or at least limits, the possibility of said container tipping over when said closing plate is in the open position.
